(19) United States
(12) Patent Application Publication
(10) Pub. No.: US 2011/0260063 A1
(43) Pub. Date: Oct. 27, 2011

(54) CHARACTERIZATION OF PHYSICOCHEMICAL PROPERTIES OF A SOLID

(75) Inventors: Christian W. Huck, Innsbruck (AT); Guenter K. Bonn, Zirl (AT); Nico Heigl, Innsbruck (AT); Christine Petter, Innsbruck (AT)

(73) Assignee: UNIVERSITAET INNSBRUCK, Innsbruck (AT)

(21) Appl. No.: 12/992,561

(22) PCT Filed: May 13, 2009
(86) PCT No.: PCT/AT09/00195

§ 371 Date: Jan. 28, 2011

(30) Foreign Application Priority Data
May 13, 2008 (AT) A 762/2008

(51) Int. Cl. G01J 5/02; G01J 5/52

(52) U.S. Cl. 250/340

(57) ABSTRACT

Procedure for determining the physicochemical properties of solids, wherein a solid is subjected to near-infrared spectroscopy, with simultaneously determining at least two characterization properties of the solid (FIG. 1).

The present invention relates to a procedure for characterizing the physicochemical properties of a solid.

The characterization (determination) of physicochemical properties of a solid, for example those of a solid pharmaceutical composition, is important, for example in order to guarantee continuous quality in the production of a solid, and in the field of pharmaceutical industries, for example bio-equivalence in the administration of a solid in a pharmaceutical composition.

It is well-known that there is used near-infrared spectroscopy for characterizing the chemical property of a solid, for example a solid pharmaceutical composition, and the appropriate examination devices are already available on the market.

Surprisingly, there has been found that by means of one single measurement there may be determined simultaneously several characterization properties of a solid.

In one aspect, the present invention provides a procedure for determining physicochemical properties of a solid, characterized in that a solid is subjected to near-infrared spectroscopy, with simultaneously determining two characterization properties of the solid.

A solid according to the present invention includes a solid composition, for example a solid pharmaceutical composition containing at least one active agent in addition to an excipient; with the solid comprising tablets, powders or granulates.

The basis for near-infrared spectroscopy (NIRS) is well-known. Excitation of molecules is realized in a wavelength range between 780 and 2500 nm or a wave number range from 4000 to 12800 cm⁻¹. These wavelength range or wave number range, respectively, are preferred according to the present invention.

The energy intensity of the infrared radiation is too low in order to initiate the types of electronic transitions known from ultraviolet and visible radiation. Hence, the absorption of infrared radiation is mainly restricted to molecules, the different vibration and rotation states of which have only little energy differences. Prerequisite for the absorption of infrared radiation is the overall change of the dipole moment as a consequence of its vibration and rotation energy, thus making it possible that the alternating electric field of the radiation interacts with the molecule and hence initiates a change of amplitude of its movement. If energy supply is lower than necessary for the stimulation of vibration, molecules may only be excited to rotate, this is there are excited molecule vibrations in the range of mid- and near-infrared, and molecule rotation is initiated at far-infrared. The absorption bands at near-infrared (4000-12800 cm⁻¹) comprise harmonic oscillations and combinations of oscillation states (basic oscillations) excited in the mid-infrared range. Hence, the corresponding absorption coefficients of substances in near-infrared in general are much smaller than the bands forming in mid-infrared.

The measurement principle of NIRS is that the light emitted by the light source is adjusted to the predetermined wavelength by means of a monochromator and that the sample, for example a solid, is irradiated with this light, resulting in interaction between light and sample.

Measurement may be carried out in various ways, so that it is useful to determine the best measurement mode in a preliminary test.

→Measurement mode 1—waveguide: The waveguide has a very flexible range of application, and it may be used for determining liquids as well as solids.

→Measurement mode 2—cuvette: Only liquids may be measured by means of a cuvette, which is inserted in a cuvette channel. One advantage of the cuvette, however, is that there may be also measured rather small sample volumes.

For the NIRS measurement, there may be used different measurement techniques such as transmission, diffuse reflexion or transflexion.

In transmission the light ray penetrates the sample and is in this way reduced. After exiting the sample, the light ray is detected. This technique is predominantly used for measurements using a cuvette.

Diffuse reflexion is mainly used with powders and solids with coarse surface. By this kind of reflexion, a portion of the incident light is reflected via surface unevenness and due to the physical properties of the sample. Some of it enters the sample, is absorbed there in part and subsequently reflected by internal diffusion processes back to the surface.

Transflexion is a combination of transmission and diffuse reflexion. The sample is penetrated by the light ray and subsequently diffusely reflected. The reduced light ray penetrates the sample again and then moves through the waveguide to the detector.

According to the present invention, there is preferably measured transmission, diffuse reflexion or transflexion, especially the diffuse reflexion of light.

Preliminary to the actual NIRS measurement it is recommendable to elaborate a suitable sample preparation method to provide for maximum precision and repeatability of the subsequent spectroscopy measurement.

There has been found, for example in the NIRS measurement of various solid compositions of amoxicillin trihydrate, as used as a medicament, that particle agglomerates were existent which could result in measurement errors or false interpretations in regard to the parameters to be determined.

In such a case it is recommended to suspend the solid compositions in a non-solvent. In the case of amoxicillin trihydrate, chloroform has proved especially suitable as non-solvent as it has only little inherent absorption in the near-infrared range, with the measurement taking place in diffuse reflexion.

According to the present invention, the information acquired by means of NIRS is used to elaborate a qualitative and quantitative model of the solid by means of mathematical, statistical, Multivariate methods as well as chemometry (chemometric software tools).

According to the present invention, there are simultaneously determined at least two, for example also three or more, characterization properties of the solid, with the physicochemical properties of solids comprising chemical and physical characterization properties, for example two, especially three, physical characterization properties such as particle size, specific surface area and porosity. The determination of physical characterization properties according to the present invention may be carried out according to suitable, for example well-known, methods, or as described herein, with preferably, however, being determined simultaneously at least two, and especially three, physical characterization properties in one single NIRS measurement.

According to the present invention, a chemical characterization property of the solid comprises a qualitative and a quantitative determination of the active agent, a qualitative and a quantitative determination of the residual solution content, especially water content, and, in the case of a solid pharmaceutical composition, additionally a qualitative and a quantitative determination of its total composition.

The determination of such chemical characterization properties according to the present invention may be performed with the help of suitable methods, for example according to well-known methods, with there being determined in one embodiment of the invention at least two chemical characterization properties simultaneously in one single NIRS measurement.

In another embodiment of the present invention, there is evaluated (determined) at least one chemical and at least one physical characterization property by means of one single measurement.

According to the present invention, there are used mathematical, statistical and Multivariate methods and chemometric software tools, apart from near-infrared spectroscopy, in order to determine the characterization properties.

The combination of NIRS with mathematical, statistical and Multivariate methods and chemometric software tools may be realized according to suitable methods, for example by means of a computer. Therefore, there may be established on the basis of known and measured values at first qualitative and quantitative calibration tables, corresponding to the various characterization properties of the solid, which are then used as a basis for the determination of unknown samples by comparing the respective measured values.

In a further aspect, the present invention provides a procedure for determining
physicochemical properties of solids, characterized in that
i) a solid is subjected to near-infrared spectroscopy,
ii) the measurement data obtained via near-infrared spectroscopy for a specific characterization property of a solid are compared to calibration tables obtained by means of known characterization properties of a solid, thus deriving and therewith determining a value for said specific characterization property,
   with simultaneously being determined at least two characterization properties of the solid.

The NIRS of a sample and its analysis according to one embodiment of the present invention is, for example, shown in a diagram in FIG. 1.

Light emitted by the light source is adjusted to a certain wavelength by means of a monochromator, followed by irradiation and interaction with the sample. This is followed by the measurement of the transmitted and also the diffusely reflected light by means of the corresponding detectors (detector transmittance, detector diffuse reflectance). The physicochemical information contained in the transmitted or reflected, respectively, light is then used to determine, by means of mathematical, statistical, Multivariate methods (Multivariate Data Analysis) and chemometrics (determination of physicochemical parameters), the qualitative and quantitative values on physical and chemical properties of the sample.

In another aspect the present invention provides a method for determining the characterization properties particle size, porosity and/or specific surface area of a solid, especially pharmaceutical, composition, characterized in that
i) a solid is subjected to near-infrared spectroscopy,
ii) the measured data were compared to values taken from calibration tables, having been elaborated before determination for the above given characterization properties of the solid composition, and
iii) the characterization properties of the solid composition are determined on the basis of the comparison,
   with simultaneously, especially by means of one single measurement, determining two of the above given characterization properties of the solid.

A method according to the present invention is carried out outside of a living organism (non-invasive).

According to the present invention there may be simultaneously determined in the framework of quantitative analysis, apart from particle size, also the specific surface area, which is not possible via image analysis. Furthermore, it is possible, if desired, to simultaneously also determine other parameters according to the present invention.

Another advantage of the method according to the invention is presented by the possibility to carry out, in the framework of one single measurement, simultaneously also a qualitative analysis.

Furthermore, it is possible to obtain a significant reduction of costs by means of a procedure according to the invention in routine operation, this is the decrease of expenditure of labour.

### FIGURES

FIG. 1 shows the NIRS of a sample and its analysis according to one embodiment of the present invention.

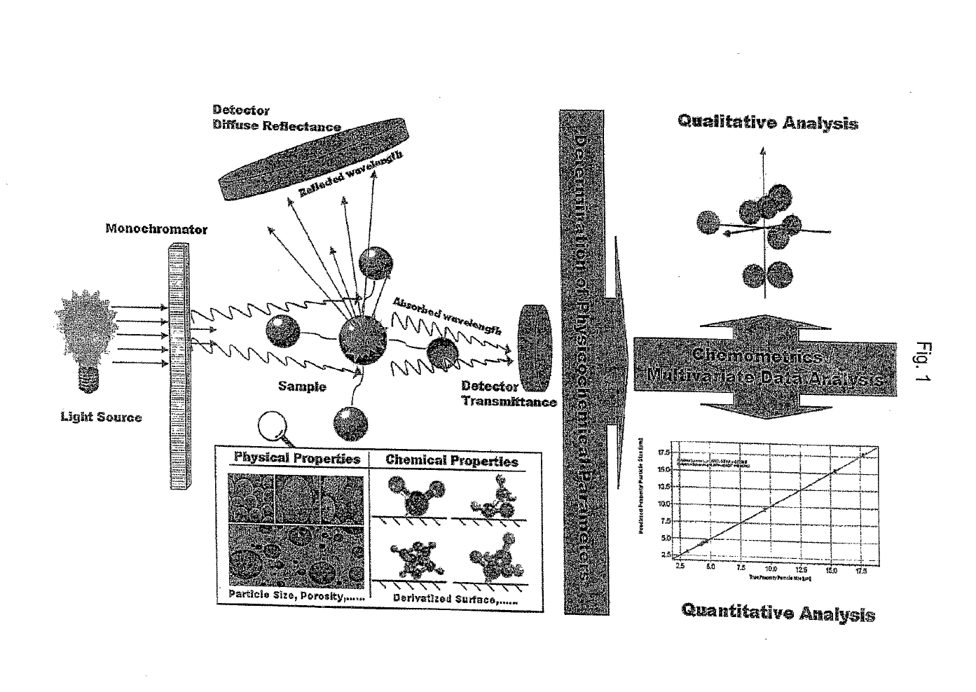

FIG. 2 shows a near-infrared absorption spectrum of amoxicillin trihydrate (wave number in cm⁻¹ vs absorption).

FIG. 3 shows in a two-dimensional factor plot the first two principal components (PC 1, PC 2), reflecting the 2 most important distinguishing properties of the samples according to table 1 in the example.

FIG. 4 shows a 2D-factor plot for every sample according to table 1 in the example (illustration in the form of an independent cluster)

FIG. 5 shows a regression model for determining particle size and shows the only little deviation of the particle size predicted by calibration from the particle size determined according to the present invention.

FIG. 6 shows a regression model for determining the specific surface area and shows deviation of the specific surface area predicted from the specific surface area determined according to the invention.

FIG. 7 shows a calibration model designed on the basis of the determined x_{(50.3)} particle sizes of 3 fractions (very fine, fine and coarse) of the AMOXI-III.

FIG. 8 shows calibration 6 of the unknown samples in a calibration model according to FIG. 7.

In the following example the present invention is explained with the help of the active agent amoxicllin trihydrate, which is present in various solid pharmaceutical compositions, with particle size and specific surface area of the particles being determined in one single NIRS measurement.

### EXAMPLE

### 1. Samples

Five different solid pharmaceutical compositions containing as active ingredient amoxicillin trihydrate (AMOX-I to AMOX-V) are subjected to near-infrared spectroscopy.

The samples have the reference values listed in table 1.

In table 1, “x_{50.3} μm” (in the figures also designated as “x(50.3)”) is a measuring unit for particle size in μm, with 80% of the particles having a particle size distribution smaller than “80% μm” and 68% of the particles having a particle size distribution listed under “68% μm” in table 1; and

“Spec. SA m²/g” is the specific surface area of the particles in m² per g.

TABLE 1

| Probe | x_{50.3} μm | 80% μm | 68% μm | Spec. SA m²/g |
|---|---|---|---|---|
| AMOX-I | 8.7 | 5.6-11.9 | 6.3-11.2 | 2.871 |
| AMOX-II | 16.1 | 9.5-22.8 | 11.0-21.3 | 2.491 |
| AMOX-III | 17.1 | 9.7-24.4 | 11.3-22.8 | 2.409 |
| AMOX-IV | 29.0 | 17.5-40.5 | 20.1-37.9 | 1.792 |
| AMOX-V | 19.6 | 8.4-30.7 | 10.9-28.2 | |

The samples are suspended in chloroform, the obtained suspensions are then dried over a defined period of time and irradiated with monochromatic light of a wavelength corresponding to near-infrared. The measurement is carried out by means of a horizontal sample measurement table in diffuse reflexion.

### 2. Analysis of the Obtained Measurement Values

There is elaborated a qualitative as well as quantitative model. The qualitative model is supposed to provide the confirmation that the selected and established system of analysis allows for the exact differentiation of different particle sizes. The precise determination of the particle sizes is finally based on the quantitative model.

### 2.a Qualitative Model and Qualitative Analysis

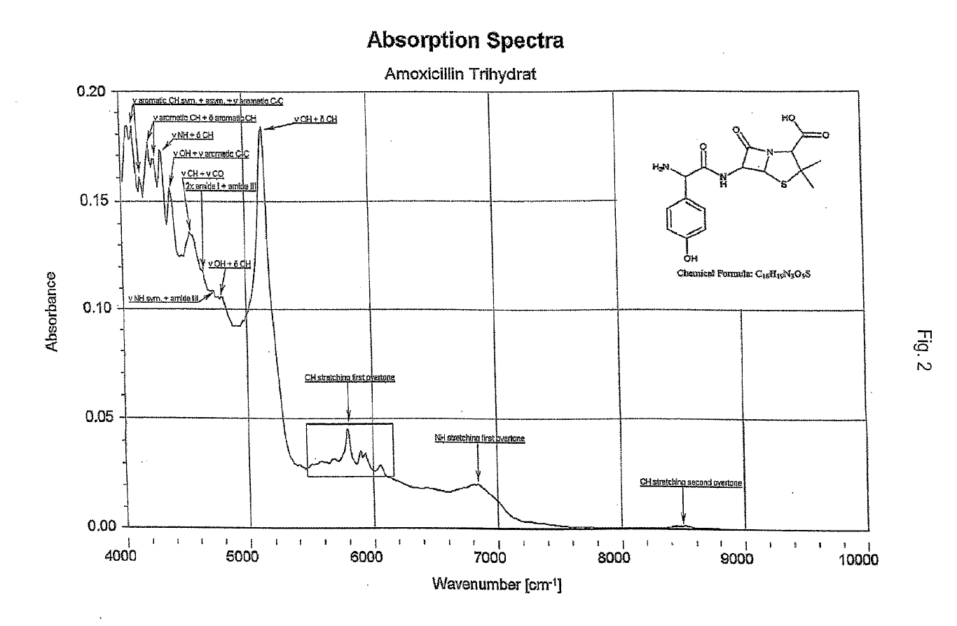

Qualitative examinations are used to determine the existent physical differences of the samples and to interpret the characteristics of infra-red spectra via the assignment of the occurring absorption bands. FIG. 2 shows an infrared absorption spectrum of amoxicillin trihydrate.

There is developed by means of chemometric software a cluster model based on Principal Component Analysis (PCA). This model makes it possible to differentiate and classify the samples. Before the samples are quantified, there is determined whether and how the samples are different to each other and whether there is visible some sort of correlation.

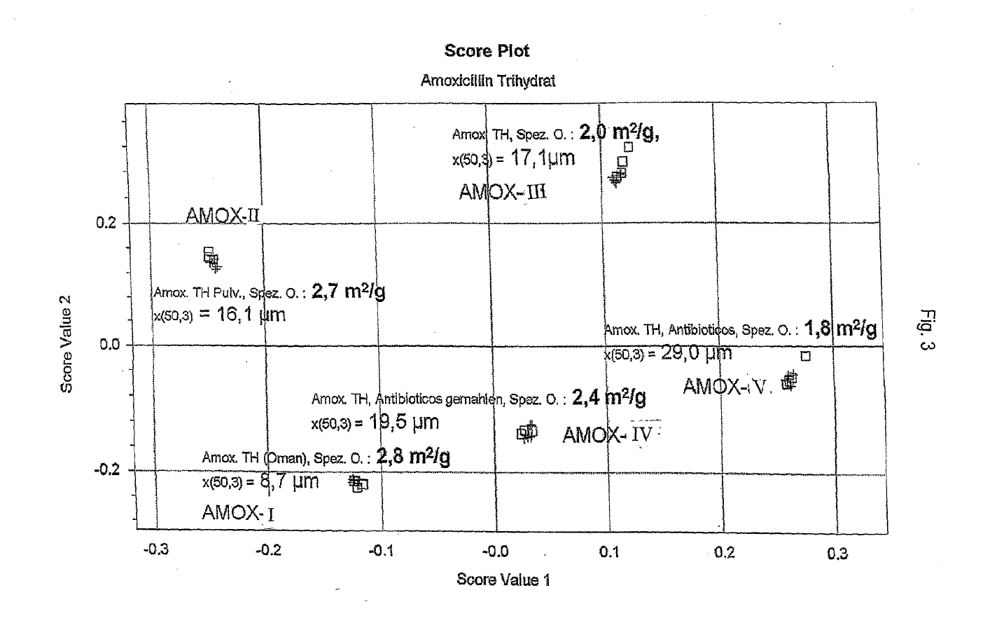

The two-dimensional factor plot in FIG. 3 shows the first two principal components (PC 1, PC 2), which reflect the two most influential distinguishing properties of the samples. By means of PC 1 there may be provided information in regard to the specific surface areas, this is from the left to the right, the specific surface area (Spec. SA m²/g) of the individual samples will increase.

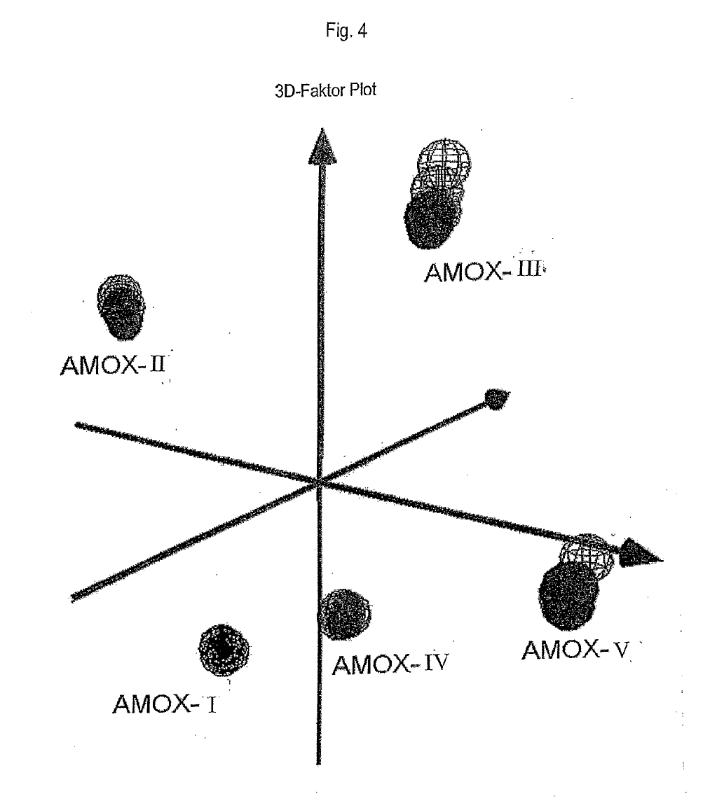

Furthermore, every sample may be illustrated in an independent cluster (FIG. 4), which, in turn, shows that this may lead to sufficient spectrum differences of the samples measured.

The result thereof is that each sample has a characteristic spectrum. By means of this model, there may then be classified unknown samples. The Q value indicates the quality of calibration, this is when Q=1, there may be assumed that the model is very precise and robust. For the cluster model calculated in the present case, there was obtained a Q value of 0.955664, representing the high quality of the model.

The calibration parameters for the qualitative analysis are as follows:

| Spectra Resolution | 12 1/cm |
|---|---|
| Spectra y-Unit | Reflectance |
| Wavelengths Project Set | 4008-9996. (total 500/500) |
| Wavelengths Calibration Set | 4008-9996 [1/cm] (total 500/500) |
| Number of Data Pretreatments | 1 |
| Data Pretreatment Sequence | 1. Normalization by Closure*, |
| | 4008-9996 |
| Method | Cluster |
| Max Iterations | 3000 |
| Mean Centering | yes |
| Number of Primary Factors | 2 |
| Secondary/Calibration Factors | 1-2. (total 2/2) |
| Residual Blow Up | 2 |
| Loading Blow Up | 1 |
| Radii Blow Up | 2 |
| Radii Formula | 2 |
| Max C-Set Spectra Residual | 0.00252629 |
| Min C-Set Spectra Residual | 0.000922151 |
| Validation Parameter Residual | 2 |
| Blow Up | |
| Max Allowed Residual for Calibration | 0.00505259 |
| Min Allowed Residual for Calibration | 0.000461075 |
| Q-Value | 0.955664 |

and further listed in table 2.

TABLE 2

| Property | Num | C num | V num | U num |
|---|---|---|---|---|
| Overview | Cluster | Spec | Spec | Spec |
| Total Sum | 5 | 32 | 16 | 2 |
| AMOX-I | 1 | 6 | 4 | 0 |
| AMOX-V | 1 | 7 | 3 | 0 |
| AMOX-IV | 1 | 6 | 3 | 1 |
| AMOX-II | 1 | 7 | 3 | 0 |
| AMOX-III | 1 | 6 | 3 | 1 |

### 2.b Quantitative Model and Quantitative Analysis

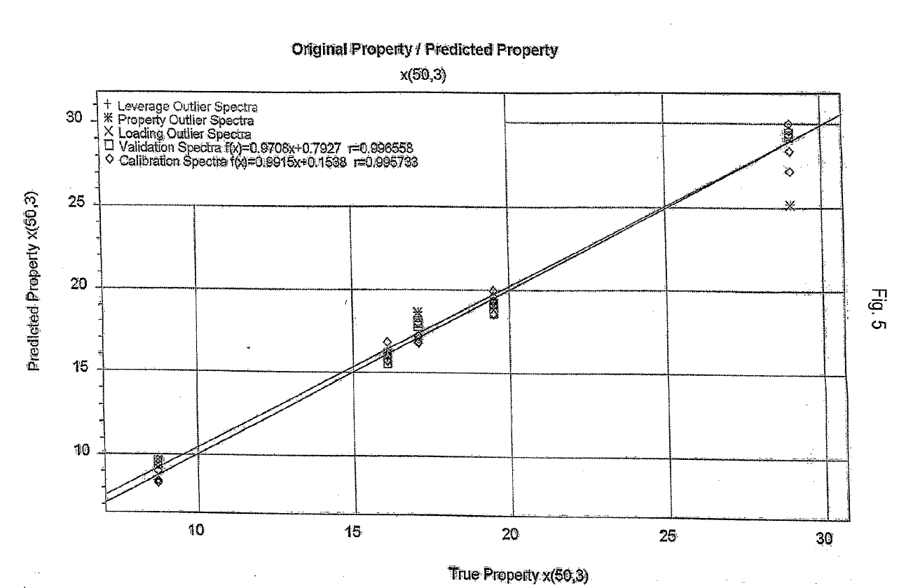

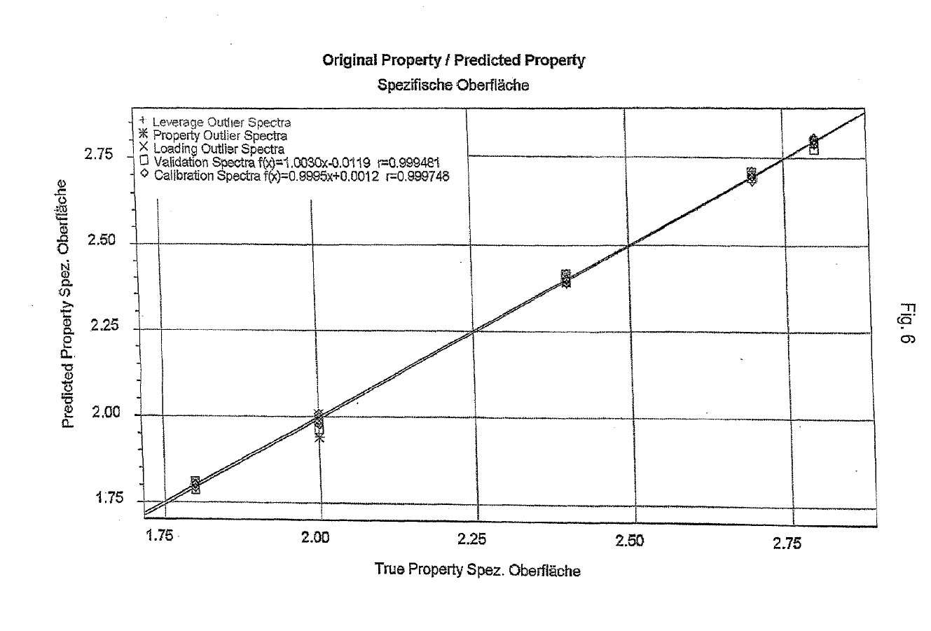

Quantitative calibration models are then based on the existent reference values, hence every spectrum is “cross-linked” with the corresponding reference values. The so-called calibration set (spectra used for calibration purposes) is validated by an independent second test set (spectra used for testing the calibration) in order to examine the quality (preciseness, robustness) of the model. Particle size calibration is based on the i x_{50.3} value, as the particle sizes are distributed within a relatively large area. Calibration may be based only on one value. For particle size determination, there was obtained a rather small prediction error (SEP) of 0.597033 μm (see FIG. 5), and for the determination of the spec. surface area there was reached a SEP of 0.0131379 m²/g (see FIG. 6).

The calibration parameters for the quantitative analysis are listed in table 3.

TABLE 3

| Spectra Resolution | 12 1/cm |
|---|---|
| Spectra y-Unit | Reflectance |
| Wavelengths Project Set | 4008-9996. (total 500/500) |
| Wavelengths Calibration Set | 4440-9000. |
| | [1/cm] (total 381/500) |
| Number of Data Pretreatments | 1 |
| Data Pretreatment Sequence | 1. Normalization by Closure*, |
| | 4440-9000 |
| Method | PCR |
| Max Iterations | 3000 |
| Mean Centering | yes |
| Number of Primary Factors | 13 |
| Secondary/Calibration Factors | 1-5. (total 5/13) |
| Blow Up Parameter | |
| Residual Blow Up | 2 |
| Loading Blow Up | 1 |
| Max C-Set Spectra Residual | 0.000488967 |
| Min C-Set Spectra Residual | 0.000231276 |
| Validation Parameter Residual | 2 |
| Blow Up | |
| Max Allowed Residual for Calibration | 0.000977934 |
| Min Allowed Residual for Calibration | 0.000115638 |
| Q-Value | 0.91736 |

| | | |
|---|---|---|
| | x(50,3) | Spec. SA |
| C-Set BIAS | −7.35E−14 | 4.02E−16 |
| V-Set BIAS | −0.281336 | 0.00474587 |
| C-Set SEE | 0.595439 | 0.00868188 |
| V-Set SEE (SEP) | 0.597033 | 0.0131379 |
| Consistency | 99.7329 | 66.0827 |
| C-Set Regression Coefficient | 0.995733 | 0.999748 |
| V-Set Regression Coefficient | 0.996558 | 0.999481 |
| C-Set Regression Intercept | 0.153812 | 0.00118507 |
| V-Set Regression Intercept | 0.792677 | −0.0118856 |
| C-Set Regression Slope | 0.991484 | 0.999496 |
| V-Set Regression Slope | 0.97077 | 1.00301 |

In the case of the spec. surface area it was possible to calculate a precise linear model, while in contrast thereto, a relatively high SEP leaves much tolerance for precise particle size predictions due to a very large distribution area of the reference values. There were again produced suspensions of the respective samples after the elaboration of the calibration models, and these were “calibrated” into the models in order to examine the prediction preciseness in regard to particle size predictions; for results in regard to calibration spectra see table 4. Results for test spectra see table 5.

TABLE 4

| | | | Predicted | | Original | |
|---|---|---|---|---|---|---|
| Spectra | | Resid- | | Spec. | | Spec. |
| name | No. | ual | x(50.3) | SA | x(50.3) | SA |
| AMOX-V | 1 | 0.0004327 | 19.0577 | 2.389 | 19.5 | 2.4 |
| AMOX-V | 2 | 0.0004014 | 19.6101 | 2.3878 | 19.5 | 2.4 |
| AMOX-V | 3 | 0.0004379 | 19.3625 | 2.3966 | 19.5 | 2.4 |
| AMOX-V | 4 | 0.0007138 | 19.1877 | 2.3928 | 19.5 | 2.4 |
| AMOX-V | 5 | 0.0004694 | 19.9505 | 2.3985 | 19.5 | 2.4 |
| AMOX-V | 6 | 0.0003877 | 19.2335 | 2.4028 | 19.5 | 2.4 |
| AMOX-V | 7 | 0.0007579 | 18.6182 | 2.4072 | 19.5 | 2.4 |
| AMOX-V | 8 | 0.000412 | 19.5954 | 2.4034 | 19.5 | 2.4 |
| AMOX-V | 9 | 0.0003869 | 18.5579 | 2.4189 | 19.5 | 2.4 |
| AMOX-V | 10 | 0.0007138 | 19.1412 | 2.4156 | 19.5 | 2.4 |
| AMOX-IV | 11 | 0.0009231 | 25.1817 | 1.7961 | 29 | 1.8 |
| AMOX-IV | 12 | 0.0002313 | 27.1728 | 1.7997 | 29 | 1.8 |
| AMOX-IV | 13 | 0.0007996 | 29.2928 | 1.7856 | 29 | 1.8 |
| AMOX-IV | 14 | 0.0002968 | 28.3608 | 1.8037 | 29 | 1.8 |
| AMOX-IV | 15 | 0.0002672 | 29.9933 | 1.7918 | 29 | 1.8 |
| AMOX-IV | 16 | 0.0008211 | 29.1793 | 1.8107 | 29 | 1.8 |
| AMOX-IV | 17 | 0.0003861 | 29.3019 | 1.8033 | 29 | 1.8 |
| AMOX-IV | 18 | 0.0003049 | 29.6043 | 1.8039 | 29 | 1.8 |
| AMOX-IV | 19 | 0.0007938 | 29.4378 | 1.8025 | 29 | 1.8 |
| AMOX-IV | 20 | 0.0003865 | 29.5728 | 1.8028 | 29 | 1.8 |
| AMOX-III | 21 | 0.0007949 | 18.6243 | 1.9412 | 17.1 | 2 |
| AMOX-III | 22 | 0.0007228 | 17.9997 | 1.9656 | 17.1 | 2 |
| AMOX-III | 23 | 0.0003941 | 18.0071 | 1.9775 | 17.1 | 2 |
| AMOX-III | 24 | 0.0004826 | 17.2519 | 1.9891 | 17.1 | 2 |
| AMOX-III | 25 | 0.0007027 | 17.789 | 1.9846 | 17.1 | 2 |
| AMOX-III | 2.60E+01 | 4.88E−04 | 16.858 | 2.0094 | 17.1 | 2 |
| AMOX-III | 27 | 0.0004127 | 17.1729 | 2.0014 | 17.1 | 2 |
| AMOX-III | 28 | 0.0006583 | 18.1145 | 1.9925 | 17.1 | 2 |
| AMOX-III | 29 | 0.0004589 | 16.7933 | 2.0102 | 17.1 | 2 |
| AMOX-III | 30 | 0.0004542 | 17.0256 | 2.0098 | 17.1 | 2 |
| AMOX-I | 31 | 0.0006506 | 9.4331 | 2.7775 | 8.7 | 2.8 |
| AMOX-I | 32 | 0.000489 | 8.4475 | 2.7973 | 8.7 | 2.8 |
| AMOX-I | 33 | 0.0004644 | 8.2963 | 2.8042 | 8.7 | 2.8 |
| AMOX-I | 34 | 0.0006379 | 9.4711 | 2.792 | 8.7 | 2.8 |
| AMOX-I | 35 | 0.0004736 | 8.324 | 2.8095 | 8.7 | 2.8 |
| AMOX-I | 36 | 0.0003338 | 9.6727 | 2.7908 | 8.7 | 2.8 |
| AMOX-I | 37 | 0.000601 | 9.6265 | 2.795 | 8.7 | 2.8 |
| AMOX-I | 38 | 0.000392 | 9.0399 | 2.8018 | 8.7 | 2.8 |
| AMOX-I | 39 | 0.0004578 | 9.4636 | 2.7925 | 8.7 | 2.8 |
| AMOX-I | 40 | 0.0006073 | 9.5093 | 2.795 | 8.7 | 2.8 |
| AMOX-II | 41 | 0.0004849 | 16.091 | 2.6973 | 16.1 | 2.7 |
| AMOX-II | 42 | 0.000393 | 15.7236 | 2.6988 | 16.1 | 2.7 |
| AMOX-II | 43 | 0.0005896 | 16.1334 | 2.6943 | 16.1 | 2.7 |
| AMOX-II | 44 | 0.0004064 | 16.848 | 2.6869 | 16.1 | 2.7 |
| AMOX-II | 45 | 0.0004353 | 16.2314 | 2.7001 | 16.1 | 2.7 |
| AMOX-II | 46 | 0.0005588 | 15.9229 | 2.7015 | 16.1 | 2.7 |
| AMOX-II | 47 | 0.0003961 | 15.6978 | 2.7022 | 16.1 | 2.7 |
| AMOX-II | 48 | 0.0004208 | 15.9795 | 2.7062 | 16.1 | 2.7 |
| AMOX-II | 49 | 0.0005603 | 15.5448 | 2.7118 | 16.1 | 2.7 |
| AMOX-II | 50 | 0.0004833 | 15.7022 | 2.7129 | 16.1 | 2.7 |

TABLE 5

| | | | Predicted | | Original | |
|---|---|---|---|---|---|---|
| Spectra | | Resid- | | Spec. | | Spec. |
| name | No. | ual | x(50.3) | SA | x(50.3) | Sa |
| AMOX-V | 51 | 0.0010663 | 16.732 | 2.4108 | 0 | 0 |
| AMOX-V | 52 | 0.0011755 | 16.7647 | 2.4052 | 0 | 0 |
| AMOX-V | 53 | 0.0010522 | 17.2179 | 2.396 | 0 | 0 |
| AMOX-II. | 54 | 0.0010074 | 19.0514 | 2.6152 | 0 | 0 |
| AMOX-II. | 55 | 0.0009163 | 19.0026 | 2.6176 | 0 | 0 |
| AMOX-II | 56 | 0.0010531 | 19.4773 | 2.6073 | 0 | 0 |
| AMOX-III | 57 | 0.0009268 | 13.9986 | 2.1036 | 0 | 0 |
| AMOX-III | 58 | 0.0010453 | 14.7551 | 2.1031 | 0 | 0 |
| AMOX-III | 59 | 0.0011162 | 13.7514 | 2.1219 | 0 | 0 |
| AMOX-IV | 60 | 0.0013135 | 20.8677 | 2.0082 | 0 | 0 |
| AMOX-IV | 61 | 0.0012667 | 21.7486 | 2.0142 | 0 | 0 |
| AMOX-IV | 62 | 0.0012254 | 20.8216 | 2.0248 | 0 | 0 |

2.c Comparison of the Quantitative NIRS Analysis with the Results Obtained Via Image Analysis

If you compare the obtained NIRS results of other amoxycillin trihydrate samples with the results obtained from state-of-the-art imaging analysis, you will find that the x-values (50.3) correlate very well, as can be seen in table 6.

TABLE 6

| | NIRS values | Image Analysis | | |
|---|---|---|---|---|
| Sample Number | x(50.3) | x(50.3) | 80% from | to |
| AMOX-VI | 15.8 | 11.7 | 5 | 18.4 |
| AMOX-VII | 9.7 | 9.2 | 3.1 | 15.2 |
| AMOX-VIII | 17.2 | 10.9 | 4.7 | 17.2 |
| AMOX-IX | 6.5 | 11.7 | 5 | 18.4 |
| AMOX-X | 22.7 | 21.0 | 10.5 | 31.4 |
| AMOX-XI | 21.5 | 26.3 | 12.1 | 40.4 |

### 2.d Further Examinations in Regard to Particle Size

Due to the too imprecise particle size reference values, there are calibrated various obtained particle size fractions for this examination. This is insofar advantageous as there are available more precise reference values, on the basis of which there can be developed a much more precise calibration model.

### Samples Used for Calibration:

AMOX-III→fraction very fine
AMOX-III→fraction fine
AMOX-III→fraction coarse

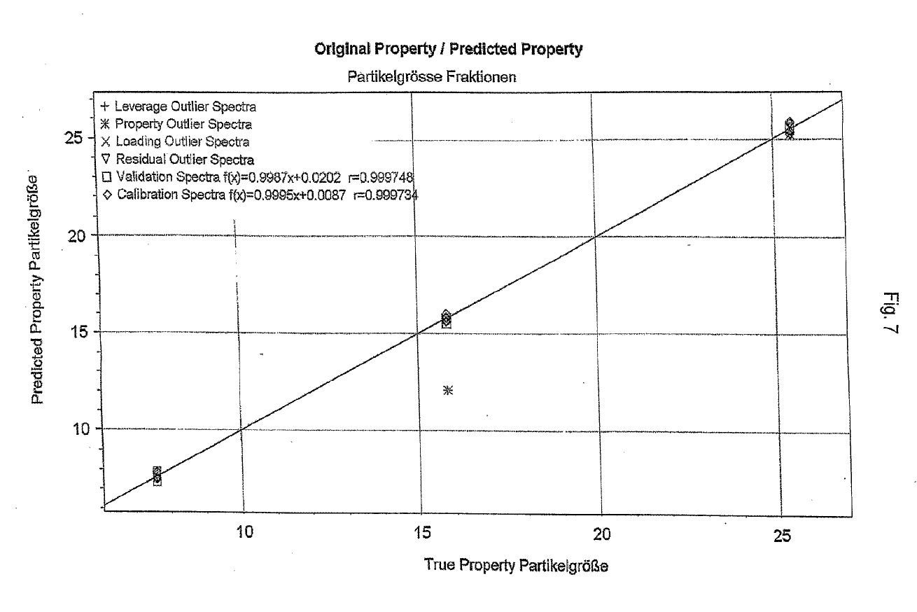

The respective fractions are suspended in CHCl₃, and subsequently the suspension is dried and analyzed. There can be elaborated a very precise calibration, as seen in FIG. 7.

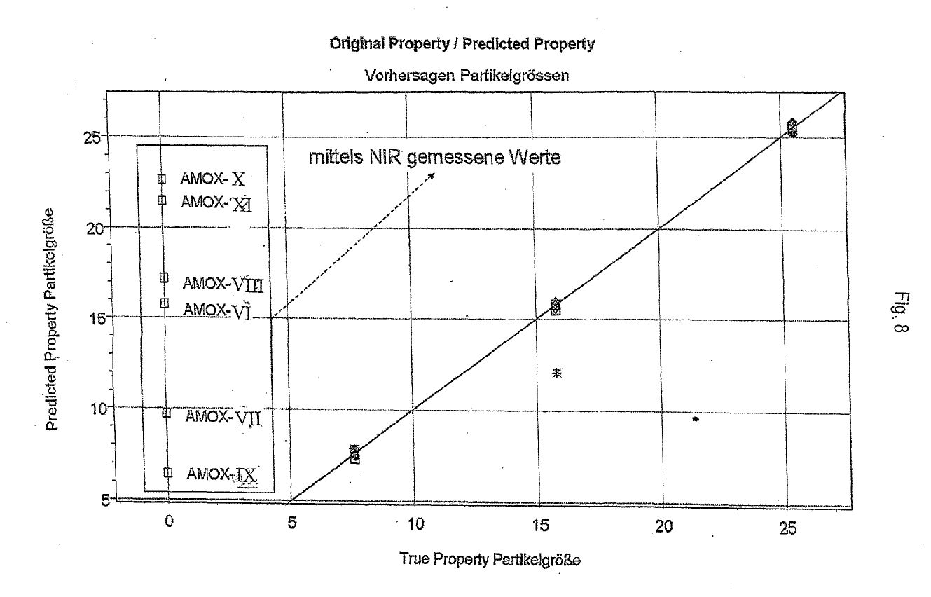

By means of calibration it is then possible to determine unknown samples (AMOX-VI to AMOX-XI), which illustrate various solid pharmaceutical compositions with amoxicillin trihydrate as active ingredient. Results see FIG. 8 and table 7.

TABLE 7

| | | | Outlier | | | Predicted |
|---|---|---|---|---|---|---|
| Spectra | | Resid- | Resid- | Outlier | Outlier | Particle |
| Name | No | ual | ual | Loading | Property | size [μm] |
| AMOX-VI | 1 | 0.1575873 | X | X | | 15.7941 |
| AMOX-VII | 2 | 0.1820489 | X | X | | 9.7166 |
| AMOX-VIII | 3 | 0.4071692 | X | X | | 17.2138 |
| AMOX-IX | 4 | 0.0681675 | X | X | X | 6.4518 |
| AMOX-X | 5 | 0.153371 | X | X | | 22.6597 |
| AMOX-XI | 6 | 0.1141766 | X | X | | 21.4794 |

According to FIG. 7 there may be calculated a very precise prediction model. In order to test the model under real conditions, there were calibrated six unknown samples in the model. A prediction error (SEP) of only 0.174401 μm displays the precise predictability of the model in regard to unknown samples. On the basis of more precise indications of the particle size reference values, in these examinations it was possible to reduce the SEP in comparison to earlier examinations from 0.597033 μm to 0.174401 μm.

1. A method for determining physiochemical properties of solids, the method comprising:
subjecting a solid to near-infrared spectroscopy; and
simultaneously determining at least two characterization properties of the solid.

2. A method according to claim 1, comprising simultaneously determining at least three characterization properties of the solid.

3. A method according to claim 1, characterized in that the solid comprises a solid pharmaceutical composition.

4. A method according to claim 3, characterized in that the solid pharmaceutical composition comprises tablets, powders, or granulates.

5. A method according to claim 1, characterized in that physicochemical properties of solids includes chemical and/or physical characterization properties.

6. A method according to claim 5, characterized in that physicochemical properties of solids comprises physical characterization properties.

7. A method according to claim 5, comprising simultaneously determining at least two physical characterization properties of the solid.

8. A method according to claim 5, characterized in that the physical characterization property of the solid comprises its particle size, specific surface area or porosity.

9. A method according to claim 5, characterized in that a chemical characterization property of the solid comprises a qualitative and a quantitative determination of the active ingredient, a qualitative and a quantitative determination of the residual solution content, or, in the case of a solid pharmaceutical composition, in addition a qualitative and a quantitative determination of its total composition.

10. A method according to claim 1, characterized in that the near-infrared spectroscopy is performed in a wavelength area of 780 nm to 2500 nm.

11. A method according to claim 1, comprising irradiating the solid with monochromatic light, and measuring transmission, diffuse reflexion or transflexion.

12. A method according to claim 1, comprising determining at least one chemical and at least one physical characterization property by one single measurement.

13. A method according to claim 1, characterized in that there are used, apart from near-infrared spectroscopy, mathematical, statistical and Multivariate methods and chemometric software tools for the determination.

14. A method according to claim 1, characterized in that measurement data obtained via near-infrared spectroscopy for a specific characterization property of a solid are compared with calibration tables, which are produced by known characterization properties of a solid, leading to the derivation and hence determination thereof of a value for said specific characterization property.

15. A method for determining the characterization properties particle size, porosity and/or specific surface area of a solid composition, the method comprising:
i) subjecting a solid to near-infrared spectroscopy,
ii) comparing measured data of the near-infrared spectroscopy with values taken from calibration tables, elaborated before the determination of the above given characterization properties of the solid composition, and
iii) on the basis of this comparison, determining the characterization properties of the solid composition,
with there being determined simultaneously at least two of the above indicated characterization properties of the solid.

16. A method according to claim 1, characterized in that the method is carried out outside of a living organism (non-invasive).

17. A method according to claim 15, characterized in that the method is carried out outside of a living organism (non-invasive).

18. A method according to claim 15, characterized that at least two indicated characterization properties are determined simultaneously from one single measurement.
